(19) United States
(12) Patent Application Publication
(10) Pub. No.: US 2006/0226306 A1
(43) Pub. Date: Oct. 12, 2006

(54) Eyewear display device

(76) Inventors: Greg Smith, Plano, TX (US); Phil Langley, Plano, TX (US)

Correspondence Address: STORM LLP, BANK OF AMERICA PLAZA, 901 MAIN STREET, SUITE 7100, DALLAS, TX, 75202, US

(21) Appl. No.: 11/104,028

(22) Filed: Apr. 12, 2005

(51) Int. Cl. F16L 3/00

(52) U.S. Cl. 248/121

(57) ABSTRACT

The present invention discloses a unique and novel display device for attaching an auxiliary lens assembly to a primary lens assembly. A display mount is disclosed that allows auxiliary eyewear to be displayed along with the primary eyewear to which it combines. The primary lens assembly can be supported in a conventional manner in an existing display rack. The auxiliary eyewear display mount is attachable to the bridge portion of the primary lens assembly with a hand-operated clamp. An arm extends from the clamp to an auxiliary cradle that supports the auxiliary lens assembly.

### RELATED ART

This application claims priority to U.S. Provisional Patent No. ______, which was filed on ______.

### TECHNICAL FIELD OF INVENTION

The present invention relates to eyewear, and in particular, to a display device for displaying a primary lens assembly and auxiliary lens assembly. More specifically, the present invention discloses a novel and stylish display device that allows the auxiliary lens assembly to be displayed along with the primary lens assembly with which it is designed to combine. The auxiliary lens assembly can be supported on a conventional vertical bar display rack having a bridge support. The disclosed eyewear display device is attachable to the vertical bar display rack above the existing bridge support. The primary lens assembly is supported on one of multiple positions on the display device.

### BACKGROUND OF THE INVENTION

The eyewear market provides numerous options for people who rely on eyewear in their daily lives. The multitude of different requirements that individuals have, has created a large market of auxiliary lens systems of eyewear. In these systems, a primary lens assembly is augmented by an auxiliary lens assembly. The combinations provide numerous options for satisfying individual requirements for visual assistance and protection.

An example of the utility of combining a primary lens assembly with an auxiliary lens assembly is when the primary lenses are corrective lenses and the auxiliary lenses are light transmission reducing lenses, for example, a polarizing, absorbing, refracting, photochromatic, or reflecting lenses, or any combination thereof (i.e., sunglasses). Another example is when the primary lenses are corrective lenses and the auxiliary lenses are impact resistant safety lenses.

The recent surge in popularity of these devices has created a need for a means to display the devices for retail selection and purchase. Presently, there are no devices available for conveniently displaying to the prospective buyer, both the primary and auxiliary lens assemblies, in a manner that allows the prospective buyer to see how the primary and auxiliary lens assemblies together, and that utilizes existing displays.

Presently, numerous display systems permit display and accessibility to a single lens assembly. For example, U.S. Patent US D478,227 S to Peyker discloses an ornamental design for a display case for eyewear. U.S. Patent D426,998 to Kidd, discloses another ornamental design for a display case for eyewear. The principal disadvantage of these designs is that they only support a primary lens assembly, and are not capable of displaying an auxiliary lens assembly, or a primary and auxiliary lens assembly combination.

U.S. Patent Des. 371,458 discloses an eyewear support for a display tray. While this support is limited to working in conjunction with tray display system, it also is limited to supporting a singular primary lens assembly.

Auxiliary eyewear systems such as those described above can only support a primary lens assembly to the exclusion of the auxiliary lens assembly. Most of the various prior art designs cannot support an auxiliary lens assembly in a portal for a primary lens assembly, because the auxiliary lens assemblies lack the pivotally attached legs for going over the ears of the wearer that are commonly used to attach the primary lens assembly in the display device. Another disadvantage of the various prior art designs is that they cannot display a primary and auxiliary lens assembly combination.

It can thus be seen that there is a need to develop a design for a device capable of displaying both primary lens assemblies and auxiliary lens assemblies, which allows close comparison of the matching features of the primary lens assemblies and auxiliary lens assemblies, and which can be used in combination with the existing display devices of retail eyewear outlets.

### SUMMARY OF THE INVENTION

A primary advantage of the present invention is that it provides a device capable of displaying both primary lens assemblies and auxiliary lens assemblies. Another advantage of the present invention is that it provides a display device for auxiliary lens assemblies that can be used in combination with existing retail outlet display systems that otherwise support only primary lens assemblies. Another advantage of the present invention is that it is easy to use and allows immediate removal of both the auxiliary lens assembly or the primary lens assembly.

Another advantage of the present invention is that it is simple and aesthetically attractive. Another advantage of the present invention is that it permits removal of the primary lens assembly for inspection without the necessity for removal of the auxiliary lens assembly. Other advantages of the present invention will become apparent from the following descriptions, taken in connection with the accompanying drawings, wherein, by way of illustration and example, an embodiment of the present invention is disclosed. As referred to hereinabove, the “present invention” refers to one or more embodiments of the present invention which may or may not be claimed, and such references are not intended to limit the language of the claims, or to be used to construe the claims in a limiting manner.

A primary lens assembly is capable of retaining a pair of primary lenses. An auxiliary lens assembly is capable of retaining a pair of auxiliary lenses. The auxiliary lens assembly is removably attachable to the primary lens assembly. In this manner, the person wearing the eyewear system has two lenses combining to alter the transmission of light to the eyes. The present invention discloses an eyewear display mount capable of removable attachment to a vertical rod display system, without the use of tools or adhesives.

In accordance with one aspect of the invention, there is disclosed a unique eyewear display mount which is removably attachable to a vertical rod display system. Such systems are well known in the art and readily commercially available in abundance. They provide a vertical rod stand having bridge supports located in spaced apart relation along the rod. Eyewear is placed on the bridge supports for display.

In the preferred embodiment, an eyewear display device is disclosed having a body. In a more preferred embodiment, a hollow cylindrical center is formed in the body for mounting onto a rod. A neck extends outward from the front of the body. A pair of wings extending outward from the sides of the body. In a more preferred embodiment, a slot is formed on the back of the body to facilitate snap-on attachment onto the vertical display rod.

In another preferred embodiment, a pair of legs extend downward from the sides of the body, to permit stable positioning of the device on top of the prior art bridge support devices.

In another preferred embodiment, a pair of feet extend forward of the body. The feet provide still greater stability of the device in relation to the existing bridge support device, and stabilize the auxiliary lens assembly on the existing bridge support device.

In another preferred embodiment, a pair of wingtips extend upwards from the ends of the wings. The wingtips help to secure the legs of the primary lens assembly onto the display device.

In another preferred embodiment, the wings are arched, providing an enhanced esthetic appeal to the device.

In another preferred embodiment, a notch is formed on the top of the neck providing a stable position for locating the bridge of a lens assembly.

In another preferred embodiment, a flat is formed on the top of the neck, providing an alternative display configuration of the lens assembly.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an isometric view of a preferred embodiment of the present invention, disclosing the eyewear display device of the present invention.

FIG. 2 is an isometric view of the prior art.

FIG. 3 is an isometric view of a preferred embodiment of the present invention disclosing the device attached to the prior art shown in FIG. 2, and disclosing a preferred mounting configuration of the lens assemblies.

FIG. 4 is a side isometric view of a preferred embodiment of the present invention disclosed in FIG. 3.

FIG. 5 is an isometric view of a preferred embodiment of the present invention.

FIG. 6 is a rear view of a preferred embodiment of the present invention.

FIG. 8 is a front view of a preferred embodiment of the present invention.

FIG. 7 is a side view of a preferred embodiment of the present invention.

FIG. 9 is a top view of a preferred embodiment of the present invention.

FIG. 10 is a top view of a preferred embodiment of the present invention, showing a primary lens assembly mounted to a preferred embodiment of the display device.

FIG. 11 is an isometric view of a preferred embodiment of the present invention, disclosing the eyewear display device of the present invention.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The terms “right” and “left” as used herein are referenced from the perspective of a person wearing the primary and auxiliary lens assemblies. The references are intended to aide in the description of the device, and are not intended to be limiting, since the preferred embodiments of the device are generally symmetric.

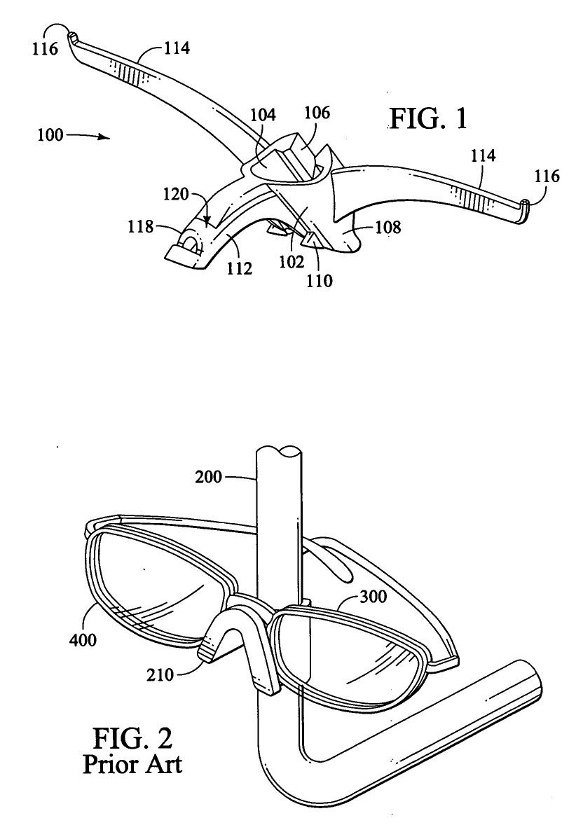

FIG. 1 is an isometric view of a preferred embodiment of the present invention, disclosing eyewear display device 100. Display device 100 has a body portion 102. Numerous features may be incorporated into the design of body 102. In the preferred embodiment disclosed in FIG. 1, a hollow cylindrical center 104 is formed in body 102. A slot 106 is formed along the backside of body 102. A pair of legs 108 extends downward from the sides of body 102. A pair of feet 110 extend forward from the bottom front of body 102.

A neck 112 extends outward from the front of body 102. A pair of wings 114 extend outward from the sides of body 102. In a more preferred embodiment, a pair of wingtips 116 extends upwards from the ends of wings 114. In another preferred embodiment, a notch 118 is formed on the top of neck 112. In another preferred embodiment, a flat 120 is formed on the top of neck 112.

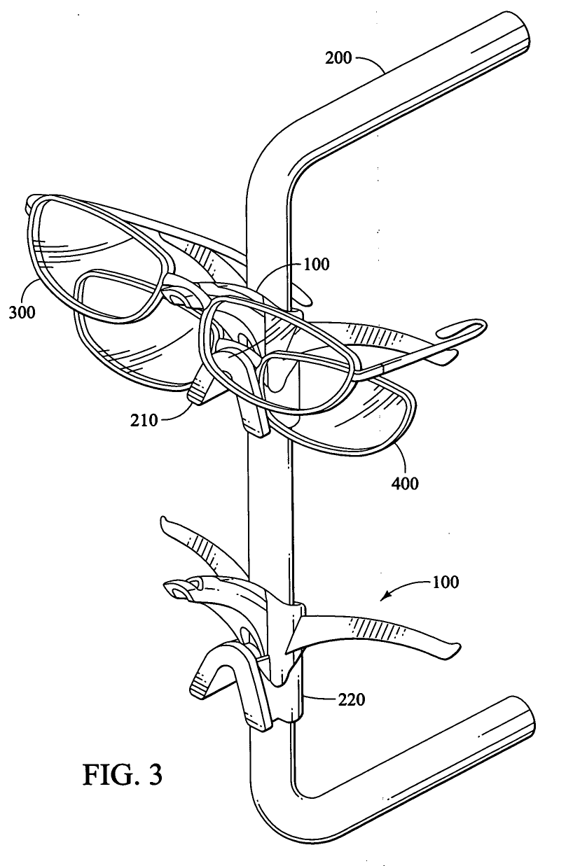

FIG. 2 is an isometric view of the prior art, showing a vertical display rod 200, having a bridge support 210 attached to rod 200. A primary lens assembly 300 is mounted on bridge support 210. An auxiliary lens assembly 400 is attached to primary lens assembly 300.

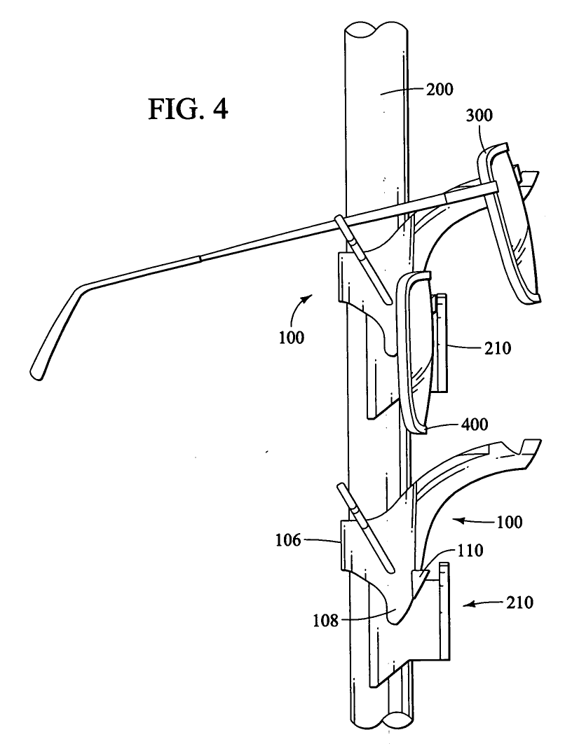

FIG. 3 is an isometric view of a preferred embodiment of display device 100 attached to prior art rod 200 shown in FIG. 2. In the preferred method of attachment, display device 100 rest on top of bridge support 200. In an alternative method not shown, display device 100 attached to rod 200, without relationship to a bridge support 210. As seen in FIG. 3, primary lens assembly 300 can be mounted on display device 100, while auxiliary lens assembly 400 is mounted on bridge support 210.

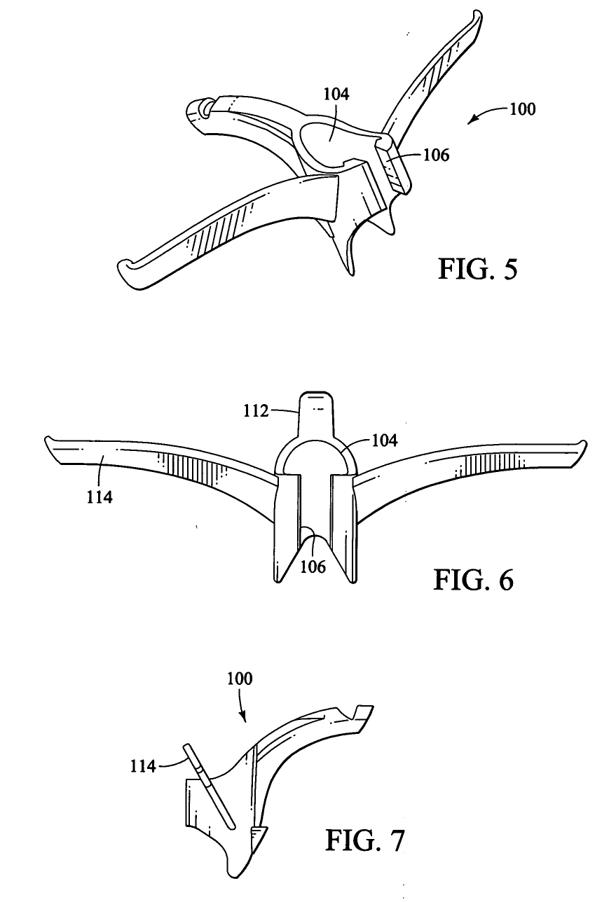

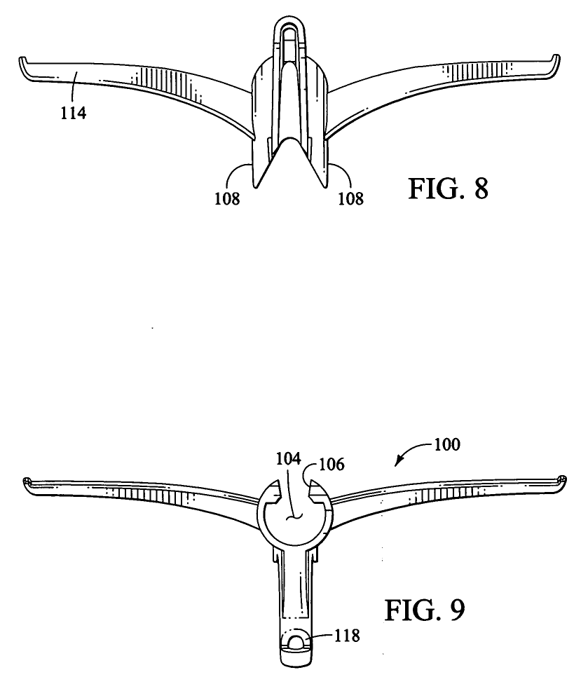

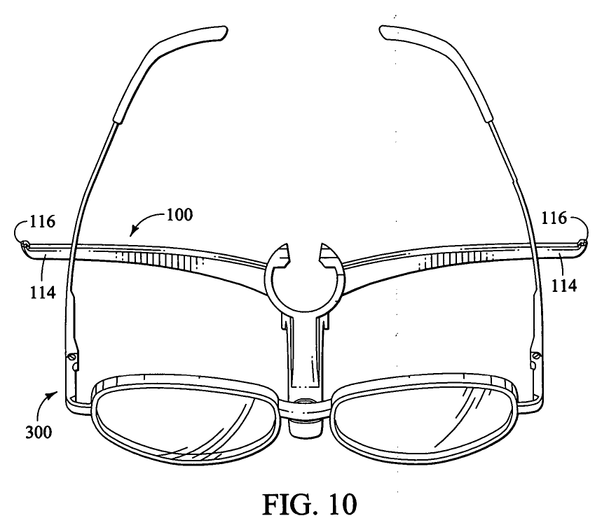

FIG. 4 is a side isometric view of a preferred embodiment of display device 100. FIG. 5 is an isometric view of the preferred embodiment of display device 100. FIG. 6 is a rear view of a preferred embodiment of display device 100.

FIG. 7 is a side view of the preferred embodiment of display device 100.

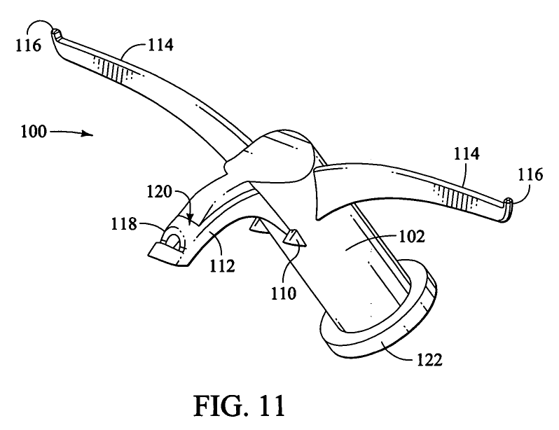

FIG. 8 is a front view of the preferred embodiment of display device 100.

FIG. 9 is a top view of the preferred embodiment of display device 100.

FIG. 10 is a top view of a preferred embodiment of the present invention, showing a primary lens assembly mounted to the preferred embodiment of display device 100.

FIG. 11 is an isometric view of an alternative preferred embodiment of display device 100, disclosing display device 100 as a stand-alone unit without the need for hollow cylindrical center 104 or slot 106. Is this embodiment, body 102 may be solid. A base 122 is attached to the bottom of body 122 to allow display device 100 to stand stability on a table top or other surface.

### OPERATION OF THE PREFERRED EMBODIMENTS

FIG. 3 is an isometric view of a preferred embodiment of display device 100 attached to prior art rod 200 shown in FIG. 2. As best seen in FIG. 3, display device display device 100 may be clipped onto rod 200 by pressing slot 106 against rod 200 until slot 106 expands sufficiently to accommodate the diameter of rod 200. In this manner the inside diameter of hollow cylindrical center 104 is preferably slightly less than the outside diameter of rod 200 to permit an interference fit of display device 100 on rod 200.

Also shown in this view, display device 100 is positionable directly above bridge support 210. In the position, legs 108 act to secure display device 100 on top of bridge support 200 and resist independent rotation. This configuration permits the easy and quick assembly of the display, without the need for instructions, adhesives, assistance, or tools.

An auxiliary lens assembly 400 can be located on bridge support 210, in the manner known for placing a primary lens assembly 300 on bridge support 210 devices. Since auxiliary lens assembly 400 alone lacks the balancing assistance provided by the legs of primary lens assembly 300 when engaging bridge support 220, it may be unstable. To address this issue, feet 110 may be provided, extending forward from body 102 of display device 100, to further stabilize auxiliary lens assembly 400.

In this manner, auxiliary lens assembly 400 can be displayed in visible and comparable combination with primary lens assembly 300. Primary lens assembly 300 may in turn be mounted in many of the existing eyewear display devices utilized for retail sales. Use of the present invention thus allows a potential purchaser to view the compatibility of primary lens assembly 300 with auxiliary lens assembly 400, and to physically remove primary lens assembly 300 from display device 100 without the need to handle auxiliary lens assembly 400. This is important since it is primary lens assembly 300 that most potential purchasers want to try on, in an indoor environment, without attachment of auxiliary lens assembly 400.

It will be readily apparent to those skilled in the art, and the general principles defined herein may be applied to other embodiments and applications without departing from the spirit and scope of the present invention. One skilled in the art will specifically recognize that alternative arrangements of the disclosed components can achieve an equivalent function and result without departing from the spirit and scope of the present invention.

I claim:

1. An eyewear display device, comprising:
a body;
a neck extending outward from the front of the body; and,
a pair of wings extending outward from the sides of the body.

2. The eyewear system of claim 1, further comprising:
a hollow cylindrical center formed in the body;

3. The eyewear system of claim 1, further comprising:
a slot formed on the back of the body;

4. The eyewear system of claim 1, further comprising:
a pair of legs extending downward from the sides of the body.

5. The eyewear system of claim 1, further comprising:
a pair of feet extending forward of the body.

6. The eyewear system of claim 1, further comprising:
a pair of wingtips extending upwards from the ends of the wings.

7. The eyewear system of claim 1, further comprising:
whereas the wings are arched.

8. The eyewear system of claim 1, further comprising:
a notch formed on the top of the neck.

9. The eyewear system of claim 1, further comprising:
a flat formed on the top of the neck.
